(19) United States
(12) Patent Application Publication
(10) Pub. No.: US 2022/0033568 A1
(43) Pub. Date: Feb. 3, 2022

(54) CURING AGENT FOR EPOXY RESIN ADHESIVES

(71) Applicant: SIKA TECHNOLOGY AG, Baar (CH)

(72) Inventors: Edis KASEMI, Zürich (CH); Andreas KRAMER, Zürich (CH); Ursula STADELMANN, Zürich (CH); Urs BURCKHARDT, Zürich (CH); Ulrich GERBER, Uitikon-Waldegg (CH)

(73) Assignee: SIKA TECHNOLOGY AG, Baar (CH)

(21) Appl. No.: 17/277,209

(22) PCT Filed: Sep. 30, 2019
(86) PCT No.: PCT/EP2019/076494

§ 371 Date: Mar. 17, 2021

(30) Foreign Application Priority Data
Oct. 1, 2018 (EP) 18198004.6

(51) Int. Cl. C08G 59/24; C08G 59/50; C08K 3/36; C08K 9/04; C09J 163/00; C09J 5/00; C09J 11/04; B32B 37/12

(52) U.S. Cl. CPC C08G 59/245; C08G 59/5033; C08G 59/502; C08K 3/36; C09J 2463/00; C09J 163/00; C09J 5/00; C09J 11/04; B32B 37/12; C08K 9/04

(57) ABSTRACT

A hardener for epoxy resins, containing at least one amine A1 of formula (I) and at least one amine A2 of formula (II), the weight ratio of amine A1 to amine A2 ranging between 20/1 and 1/2. The hardener allows the manufacture of low-emission epoxy resin adhesives having good workability, a sufficiently long pot-life and open time with rapid curing, high strength, low brittleness, high adhesion, in particular to steel, and a sufficiently high glass transition temperature.

### TECHNICAL FIELD

The invention relates to the field of curing agents for epoxy resins, to epoxy resin adhesives and to the use thereof for bonding, especially of steel.

### STATE OF THE ART

Room temperature curable epoxy resin adhesives are used for many applications, for example for the reinforcement of built structures by means of steel plates, for construction by means of precast concrete parts, for the fixing of components such as banisters, railings or doorframes, or repairs such as the filling of edges, holes or joins. For applications in the construction industry, they have to be usable under construction site conditions; important features for this purpose are especially easy processibility, and reliable and rapid curing at ambient outdoor temperatures. In addition, they should have high strength and bond strength on typical building materials such as concrete, steel and plastics. To have a high bond strength, the adhesive must not be too brittle, since it can otherwise break even under low stress in spite of good adhesion.

Many epoxy resin adhesives from the prior art contain, as curing agents, amino-functional adducts of polyamines such as triethylenetetramine or isophoronediamine with aromatic epoxy resins. Such products enable rapid curing and high strengths. But the separate preparation of such adducts is inconvenient and causes high viscosities, which complicates processibility, loading with fillers and wetting of the substrate surfaces. Thinning with solvents, however, is undesirable for environmental reasons. If such amines are used as curing agent in unadducted form, the materials obtained thereby are typically comparatively brittle, which is manifested in reduced strength and bond strength. Furthermore, such amines in unadducted form are prone to blushing, i.e. salt formation with carbon dioxide from the air, particularly under cold and moist conditions.

Alkylated amines as described in EP 2,151,461, EP 2,943,464, WO 2016/023839, EP 3,138,863 or EP 3,144,335 are significantly less sensitive to blushing. They are used in the prior art mainly as curing agent for epoxy resin coatings, where low viscosity and a low tendency to blushing effects are particularly important. If such alkylated amines are used as curing agent for epoxy resin adhesives, however, they result in inadequate bond strengths, especially to steel, and a low glass transition temperature.

### SUMMARY OF THE INVENTION

It is therefore an object of the present invention to provide a curing agent for epoxy resins that overcomes the disadvantages of the prior art in relation to production, viscosity, blushing, bond strength and glass transition temperature. This object is achieved by the curing agent as described in claim 1. The curing agent of the invention is based on a particular combination of at least one alkylated amine A1 and at least one amine A2 which is a dimethylaminopolyalkyleneamine.

The curing agent of the invention is easy to prepare, of very low viscosity and is not sensitive to blushing. It enables low-emission epoxy resin adhesives having good processibility, sufficiently long pot life and open time coupled with rapid curing, high strength coupled with surprisingly high bond strengths, especially to steel, and a sufficiently high glass transition temperature.

Further aspects of the invention are the subject of further independent claims. Particularly preferred embodiments of the invention are the subject of the dependent claims.

### Ways of Executing the Invention

The invention provides a curing agent for epoxy resins, comprising at least one amine A1 of the formula (I) and at least one amine A2 of the formula (II)

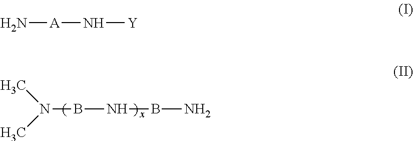

where
A is an alkylene radical that optionally contains nitrogen atoms or cyclic or aromatic components and has 2 to 10 carbon atoms,
Y is an alkyl, cycloalkyl or aralkyl radical having 1 to 20 carbon atoms,
x is 1 or 2, and
B represents identical or different alkylene radicals selected from 1,2-ethylene, 1,2-propylene and 1,3-propylene,
   where the weight ratio between amine A1 and amine A2 is in the range from 20/1 to 1/2.

A “primary amino group” refers to an amino group which is bonded to a single organic radical and bears two hydrogen atoms; a “secondary amino group” refers to an amino group which is bonded to two organic radicals which may also together be part of a ring and bears one hydrogen atom; and a “tertiary amino group” refers to an amino group which is bonded to three organic radicals, two or three of which may also be part of one or more rings, and does not bear any hydrogen atom.

“Amine hydrogen” refers to the hydrogen atoms of primary and secondary amino groups.

“Amine hydrogen equivalent weight” refers to the mass of an amine or an amine-containing composition that contains one molar equivalent of amine hydrogen.

Substance names beginning with “poly”, such as polyamine or polyepoxide, refer to substances containing, in a formal sense, two or more of the functional groups that occur in their name per molecule.

A “thinner” refers to a substance that is soluble in an epoxy resin and lowers its viscosity, and that is not chemically incorporated into the epoxy resin polymer during the curing process.

“Molecular weight” refers to the molar mass (in g/mol) of a molecule. “Average molecular weight” refers to the number average Mₙ of a polydisperse mixture of oligomeric or polymeric molecules, which is typically determined by means of gel permeation chromatography (GPC) against polystyrene as standard.

“Pot life” refers to the duration of processibility of a epoxy resin composition, i.e. the maximum possible time span between the mixing of the components and the application of the mixed composition in which it is in a sufficiently free-flowing state and is able to wet the substrate surfaces.

“Open time” of an adhesive refers to the maximum time span possible for a cohesive bond between the application of the adhesive and the joining of the parts to be bonded.

“Room temperature” refers to a temperature of 23° C.

A is preferably a divalent radical selected from the group consisting of 1,2-ethylene, 1,2-propylene, 1,3-propylene, 1,4-butylene, 1,3-butylene, 2-methyl-1,2-propylene, 1,3-pentylene, 1,5-pentylene, 2,2-dimethyl-1,3-propylene, 1,6-hexylene, 2-methyl-1,5-pentylene, 1,7-heptylene, 1,8-octylene, 2,5-dimethyl-1,6-hexylene, 1,9-nonylene, 2,2(4),4-trimethyl-1,6-hexylene, 1,10-decylene, 1,11-undecylene, 2-butyl-2-ethyl-1,5-pentylene, 1,12-dodecylene, 1,2-cyclohexylene, 1,3-cyclohexylene, 1,4-cyclohexylene, (1,5,5-trimethylcyclohexan-1-yl)methane-1,3,4(2)-methyl-1,3-cyclohexylene, 1,3-cyclohexylenebis(methylene), 1,4-cyclohexylenebis(methylene), 1,3-phenylenebis(methylene), 1,4-phenylenebis(methylene), 3-aza-1,5-pentylene, 3,6-diaza-1,8-octylene, 3,6,9-triaza-1,11-undecylene, 3-aza-1,6-hexylene and 3,7-diaza-1,9-nonylene. These amines A1 of the formula (I) are particularly readily available industrially.

Among these, preference is given to 1,2-ethylene, 1,2-propylene, 2-methyl-1,5-pentylene, 1,2-cyclohexylene, 1,3-cyclohexylene, 1,4-cyclohexylene, (1,5,5-trimethylcyclohexan-1-yl)methane-1,3,4(2)-methyl-1,3-cyclohexylene, 1,3-cyclohexylenebis(methylene), 1,4-cyclohexylenebis(methylene), 1,3-phenylenebis(methylene), 1,4-phenylenebis(methylene), 3-aza-1,5-pentylene, 3,6-diaza-1,8-octylene, 3,6,9-triaza-1,11-undecylene, 3-aza-1,6-hexylene or 3,7-diaza-1,9-nonylene.

More preferably, the radical A is free of nitrogen atoms. Such a curing agent has particularly low sensitivity to blushing effects.

More particularly, A is thus a divalent radical selected from the group consisting of 1,2-ethylene, 1,2-propylene, 1,3-propylene, 1,4-butylene, 1,3-butylene, 2-methyl-1,2-propylene, 1,3-pentylene, 1,5-pentylene, 2,2-dimethyl-1,3-propylene, 1,6-hexylene, 2-methyl-1,5-pentylene, 1,7-heptylene, 1,8-octylene, 2,5-dimethyl-1,6-hexylene, 1,9-nonylene, 2,2(4),4-trimethyl-1,6-hexylene, 1,10-decylene, 1,11-undecylene, 2-butyl-2-ethyl-1,5-pentylene, 1,12-dodecylene, 1,2-cyclohexylene, 1,3-cyclohexylene, 1,4-cyclohexylene, (1,5,5-trimethylcyclohexan-1-yl)methane-1,3,4(2)-methyl-1,3-cyclohexylene, 1,3-cyclohexylenebis(methylene), 1,4-cyclohexylenebis(methylene), 1,3-phenylenebis(methylene) and 1,4-phenylenebis(methylene).

Most preferably, A is 1,2-ethylene, 1,2-propylene or 1,3-phenylenebis(methylene). These amines A1 of the formula (I) are of comparatively low viscosity and enable adhesives having good processibility.

A is especially preferably 1,2-ethylene or 1,2-propylene. These amines A1 of the formula (I) enable adhesives having a particularly low tendency to yellowing.

A is most preferably 1,2-ethylene. These amines A1 of the formula (I) are of particularly low viscosity, are particularly readily available, and enable particularly rapid curing.

Y is preferably hexyl, 2-ethylhexyl, octyl, nonyl, decyl, undecyl, dodecyl or an optionally substituted 1-phenylethyl, 2-phenylethyl, benzyl, naphthylmethyl, cyclohexylmethyl or 2-cyclohexylethyl radical.

More preferably, Y is a radical selected from 2-ethylhexyl, 2-phenylethyl, benzyl, 1-naphthylmethyl and cyclohexylmethyl. These amines A1 of the formula (I) are of comparatively low viscosity and enable high bond strengths.

Most preferably, Y is benzyl. These amines of the formula (I) enable particularly rapid curing and particularly high bond strengths.

The amine A1 of the formula (I) is preferably selected from the group consisting of N-benzylethane-1,2-diamine, N-(1-naphthylmethyl)ethane-1,2-diamine, N-cyclohexylmethylethane-1,2-diamine, N-benzylpropane-1,2-diamine, N-benzyl-1,3-bis(aminomethyl)benzene, N-(2-ethylhexyl)-1,3-bis(aminomethyl)benzene, N-(2-phenylethyl)-1,3-bis(aminomethyl)benzene (constituent of styrenized 1,3-bis(aminomethyl)benzene, obtainable as Gaskamine® 240 from Mitsubishi Gas Chemical), N-benzyldiethylenetriamine, N-benzyltriethylenetetramine, N-benzyltetraethylenepentamine, N′-benzyl-N-(3-aminopropyl)ethylenediamine and N″-benzyl-N,N′-bis(3-aminopropyl)ethylenediamine.

The most preferred amine A1 of the formula (I) is N-benzylethane-1,2-diamine. This enables particularly rapid curing and particularly high bond strengths.

Preference is given to using the amine A1 of the formula (I) as constituent of a reaction mixture from the partial alkylation of at least one amine of the formula A(NH₂)₂ with at least one alkylating agent.

Preferably, the alkylation is a reductive alkylation, where the alkylating agent used is an aldehyde or ketone and hydrogen.

Preference is given to conducting the reductive alkylation in the presence of a suitable catalyst. Preferred catalysts are palladium on charcoal (Pd/C), platinum on charcoal (Pt/C), Adams' catalyst or Raney nickel, especially palladium on charcoal or Raney nickel.

When molecular hydrogen is used, the reductive alkylation is preferably worked in a pressure apparatus at a hydrogen pressure of 5 to 150 bar, especially 10 to 100 bar. This can be effected in a batchwise process or preferably in a continuous process.

The reductive alkylation is preferably conducted at a temperature in the range from 40 to 120° C., especially 60 to 100° C.

In the case of small volatile diamines such as ethane-1,2-diamine or propane-1,2-diamine in particular, this is preferably used in a stoichiometric ratio relative to the aldehyde or ketone and, after the alkylation, unconverted diamine is at least partly removed from the reaction mixture, especially by means of stripping. If desired, the reaction mixture may then be purified further, especially by freeing the monoalkylated amine A1 of the formula (I) at least partly of the corresponding dialkylated amine by means of distillation.

Preferably, x is 1.

Preferably, B is 1,3-propylene.

These amines A2 of the formula (II) are particularly readily available industrially.

The amine A2 of the formula (II) is preferably 3-(3-(dimethylamino)propylamino)propylamine.

The weight ratio between amine A1 and amine A2 is preferably in the range from 10/1 to 1/2, more preferably 5/1 to 1/1.5, especially 3/1 to 1/1.5.

The curing agent preferably comprises at least one further amine. The curing agent may preferably comprise a combination of two or more of the further amines specified hereinafter.

In a preferred embodiment of the invention, the curing agent comprises at least one amine A3 of the formula (III)

Y—NH-A-NH—Y (III)

where A and Y have the definitions already given.

The amine A3 of the formula (I) is preferably part of a reaction mixture from the partial alkylation of at least one amine of the formula A(NH₂)₂ with at least one alkylating agent, which also comprises the corresponding monoalkylated amine A1.

The amine A3 is preferably present in such an amount that the weight ratio between the amine A1 and the amine A3 is within the range from 50/50 to 95/5, preferably 65/35 to 95/5, especially 70/30 to 90/10. Such a mixture of amine A1 and amine A3 is readily available industrially and particularly inexpensive. More preferably, N-benzylethane-1,2-diamine and N,N′-dibenzylethane-1,2-diamine are present in a weight ratio in the range from 65/35 to 95/5, especially 70/30 to 90/10.

In a further preferred embodiment of the invention, the curing agent comprises, as a further amine, at least one amine A4 which is an aliphatic polyamine having at least two primary amino groups. The additional use of at least one amine A4 enables a particularly high glass transition temperature.

Suitable amines A4 are aliphatic, cycloaliphatic or araliphatic polyamines, especially 2,2-dimethylpropane-1,3-diamine, pentane-1,3-diamine (DAMP), pentane-1,5-diamine, 1,5-diamino-2-methylpentane (MPMD), 2-butyl-2-ethylpentane-1,5-diamine (C11 neodiamine), hexane-1,6-diamine, 2,5-dimethylhexane-1,6-diamine, 2,2(4),4-trimethylhexane-1,6-diamine (TMD), heptane-1,7-diamine, octane-1,8-diamine, nonane-1,9-diamine, decane-1,10-diamine, undecane-1,11-diamine, dodecane-1,12-diamine, 1,2-, 1,3- or 1,4-diaminocyclohexane, 1,3-bis(aminomethyl)cyclohexane, 1,4-bis(aminomethyl)cyclohexane, bis(4-aminocyclohexyl)methane, bis(4-amino-3-methylcyclohexyl)methane, bis(4-amino-3-ethylcyclohexyl)methane, bis(4-amino-3,5-dimethylcyclohexyl)methane, bis(4-amino-3-ethyl-5-methylcyclohexyl)methane, 1-amino-3-aminomethyl-3,5,5-trimethylcyclohexane (isophoronediamine or IPDA), 2(4)-methyl-1,3-diaminocyclohexane, 2,5(2,6)-bis(aminomethyl)bicyclo[2.2.1]heptane (NBDA), 3(4),8(9)-bis(aminomethyl)tricyclo[5.2.1.0^{2,6}]decane, 1,4-diamino-2,2,6-trimethylcyclohexane (TMCDA), menthane-1,8-diamine, 3,9-bis(3-aminopropyl)-2,4,8,10-tetraoxaspiro[5.5]undecane, 1,3-bis(aminomethyl)benzene (MXDA), 1,4-bis(aminomethyl)benzene, bis(2-aminoethyl) ether, 3,6-dioxaoctane-1,8-diamine, 4,7-dioxadecane-1,10-diamine, 4,7-dioxadecane-2,9-diamine, 4,9-dioxadodecane-1,12-diamine, 5,8-dioxadodecane-3,10-diamine, 4,7,10-trioxatridecane-1,13-diamine or higher oligomers of these diamines, bis(3-aminopropyl)polytetrahydrofuran or other polytetrahydrofurandiamines, cycloaliphatic diamines containing ether groups from the propoxylation and subsequent amination of 1,4-dimethylolcyclohexane, especially obtainable as Jeffamine® RFD-270 (from Huntsman), or polyoxyalkylenedi- or -triamines, especially Jeffamine® D-230, Jeffamine® D-400, Jeffamine® D-2000, Jeffamine® EDR-104, Jeffamine® EDR-148, Jeffamine® EDR-176, Jeffamine® T-403, Jeffamine® T-3000, Jeffamine® T-5000 (all from Huntsman), or corresponding amines from BASF or Nitroil, or especially a polyalkyleneamine such as bis(6-aminohexyl)amine (BHMT), diethylenetriamine (DETA), triethylenetetramine (TETA), tetraethylenepentamine (TEPA), pentaethylenehexamine (PEHA) or higher homologs of linear polyethyleneamines, dipropylenetriamine (DPTA), N-(2-aminoethyl)propane-1,3-diamine (N3 amine), N,N′-bis(3-aminopropyl)ethylenediamine (N4 amine), N,N′-bis(3-aminopropyl)-1,4-diaminobutane, N5-(3-aminopropyl)-2-methylpentane-1,5-diamine, N3-(3-aminopentyl)pentane-1,3-diamine, N5-(3-amino-1-ethylpropyl)-2-methylpentane-1,5-diamine, N,N′-bis(3-amino-1-ethylpropyl)-2-methylpentane-1,5-diamine, adducts of the abovementioned or further polyamines with epoxides or epoxy resins, especially adducts with diepoxides or monoepoxides, or polyamido amines, especially reaction products of a mono- or polybasic carboxylic acid or ester or anhydride thereof, especially a dimer fatty acid, with an aliphatic, cycloaliphatic or aromatic polyamine used in stoichiometric excess, especially a polyalkyleneamine, for example DETA or TETA, or Mannich bases, especially phenalkamines, i.e. reaction products of phenols, especially cardanol, with aldehydes, especially formaldehyde, and polyamines.

The amine A4 is preferably selected from the group consisting of TMD, 1,2-, 1,3- or 1,4-diaminocyclohexane, 1,3-bis(aminomethyl)cyclohexane, 1,4-bis(aminomethyl)cyclohexane, bis(4-aminocyclohexyl)methane, IPDA, 2(4)-methyl-1,3-diaminocyclohexane, MXDA, polyalkyleneamines, adducts of these or further polyamines with mono- or diepoxides and Mannich bases.

Among these, preference is given to IPDA or MXDA or adducts thereof with at least one epoxy resin.

Among these, particular preference is given to the polyalkyleneamines, especially TETA, TEPA, PEHA, N4 amine or BHMT, or adducts thereof with at least one epoxy resin. Such a curing agent enables particularly high bond strengths and a particularly high glass transition temperature.

The curing agent may contain a combination of two or more amines A4.

The curing agent optionally comprises at least one thinner.

Especially suitable are xylene, 2-methoxyethanol, dimethoxyethanol, 2-ethoxyethanol, 2-propoxyethanol, 2-isopropoxyethanol, 2-butoxyethanol, 2-phenoxyethanol, 2-benzyloxyethanol, benzyl alcohol, ethylene glycol, ethylene glycol dimethyl ether, ethylene glycol diethyl ether, ethylene glycol dibutyl ether, ethylene glycol diphenyl ether, diethylene glycol, diethylene glycol monomethyl ether, diethylene glycol monoethyl ether, diethylene glycol mono-n-butyl ether, diethylene glycol dimethyl ether, diethylene glycol diethyl ether, diethylene glycol di-n-butyl ether, propylene glycol butyl ether, propylene glycol phenyl ether, dipropylene glycol, dipropylene glycol monomethyl ether, dipropylene glycol dimethyl ether, dipropylene glycol di-n-butyl ether, diphenylmethane, diisopropylnaphthalene, mineral oil fractions, for example Solvesso® grades (from Exxon), alkylphenols such as tert-butylphenol, nonylphenol, dodecylphenol, cardanol (from cashew nut shell oil, containing 3-(8,11,14-pentadecatrienyl)phenol as its main constituent), styrenized phenol, bisphenols, aromatic hydrocarbon resins, especially types containing phenol groups, alkoxylated phenol, especially ethoxylated or propoxylated phenol, especially 2-phenoxyethanol, adipates, sebacates, phthalates, benzoates, organic phosphoric or sulfonic esters or sulfonamides.

Preferred thinners have a boiling point of more than 200° C.

The thinner is preferably selected from the group consisting of benzyl alcohol, styrenized phenol, ethoxylated phenol, aromatic hydrocarbon resins containing phenol groups, especially the Novares® LS 500, LX 200, LA 300 or LA 700 grades (from Rutgers), diisopropylnaphthalene and cardanol.

Thinners containing phenol groups are also effective as accelerators.

The curing agent optionally comprises at least one accelerator.

Suitable accelerators are substances which accelerate the reaction between amino groups and epoxy groups, especially acids or compounds hydrolyzable to acids, especially organic carboxylic acids such as acetic acid, benzoic acid, salicylic acid, 2-nitrobenzoic acid, lactic acid, organic sulfonic acids such as methanesulfonic acid, p-toluenesulfonic acid or 4-dodecylbenzenesulfonic acid, sulfonic esters, other organic or inorganic acids such as, in particular, phosphoric acid, or mixtures of the aforementioned acids and acid esters, nitrates such as calcium nitrate in particular; tertiary amines such as, in particular, 1,4-diazabicyclo[2.2.2]octane, benzyldimethylamine, α-methylbenzyldimethylamine, triethanolamine, dimethylaminopropylamine, imidazoles such as, in particular, N-methylimidazole, N-vinylimidazole or 1,2-dimethylimidazole, salts of such tertiary amines, quaternary ammonium salts, such as, in particular, benzyltrimethylammonium chloride, amidines such as, in particular, 1,8-diazabicyclo[5.4.0]undec-7-ene, guanidines such as, in particular, 1,1,3,3-tetramethylguanidine, phenols, especially bisphenols, phenolic resins or Mannich bases such as, in particular, 2-(dimethylaminomethyl)phenol, 2,4,6-tris(dimethylaminomethyl)phenol or polymers of phenol, formaldehyde and N,N-dimethylpropane-1,3-diamine, phosphites such as, in particular, di- or triphenyl phosphites, or compounds having mercapto groups.

Preferred accelerators are acids, nitrates, tertiary amines or Mannich bases. Particular preference is given to salicylic acid or calcium nitrate or 2,4,6-tris(dimethylaminomethyl)phenol or a combination thereof.

The invention further provides an epoxy resin composition comprising
a resin component comprising at least one epoxy resin and
a curing agent component comprising the above-described curing agent comprising at least one amine A1 of the formula (I) and at least one amine A2 of the formula (II), where the weight ratio between amine A1 and amine A2 is in the range from 20/1 to 1/2.

A suitable epoxy resin is obtained in a known manner, especially from the oxidation of olefins or from the reaction of epichlorohydrin with the polyols, polyphenols or amines.

Suitable epoxy resins are especially aromatic epoxy resins, especially the glycidyl ethers of:
bisphenol A, bisphenol F or bisphenol NF, where A stands for acetone and F for formaldehyde, which served as reactants for the preparation of these bisphenols. In the case of bisphenol F, positional isomers may also be present, especially derived from 2,4′- or 2,2′-hydroxyphenylmethane.
dihydroxybenzene derivatives such as resorcinol, hydroquinone or catechol;
further bisphenols or polyphenols such as bis(4-hydroxy-3-methylphenyl)methane, 2,2-bis(4-hydroxy-3-methylphenyl)propane (bisphenol C), bis(3,5-dimethyl-4-hydroxyphenyl)methane, 2,2-bis(3,5-dimethyl-4-hydroxyphenyl)propane, 2,2-bis(3,5-dibromo-4-hydroxyphenyl)propane, 2,2-bis(4-hydroxy-3-tert-butylphenyl)propane, 2,2-bis(4-hydroxyphenyl)butane (bisphenol B), 3,3-bis(4-hydroxyphenyl)pentane, 3,4-bis(4-hydroxyphenyl)hexane, 4,4-bis(4-hydroxyphenyl)heptane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane (bisphenol Z), 1,1-bis(4-hydroxyphenyl)-3,3,5-trimethylcyclohexane (bisphenol TMC), 1,1-bis(4-hydroxyphenyl)-1-phenylethane, 1,4-bis[2-(4-hydroxyphenyl)-2-propyl]benzene (bisphenol P), 1,3-bis[2-(4-hydroxyphenyl)-2-propyl]benzene (bisphenol M), 4,4′-dihydroxydiphenyl (DOD), 4,4′-dihydroxybenzophenone, bis(2-hydroxynaphth-1-yl)methane, bis(4-hydroxynaphth-1-yl)methane, 1,5-dihydroxynaphthalene, tris(4-hydroxyphenyl)methane, 1,1,2,2-tetrakis(4-hydroxyphenyl)ethane, bis(4-hydroxyphenyl) ether or bis(4-hydroxyphenyl) sulfone;
novolaks, which are especially condensation products of phenol or cresols with formaldehyde or paraformaldehyde or acetaldehyde or crotonaldehyde or isobutyraldehyde or 2-ethylhexanal or benzaldehyde or furfural;
aromatic amines such as aniline, toluidine, 4-aminophenol, 4,4′-methylenediphenyldiamine, 4,4′-methylenediphenyldi(N-methyl)amine, 4,4′-[1,4-phenylenebis(1-methylethylidene)]bisaniline (bisaniline P) or 4,4′-[1,3-phenylenebis(1-methylethylidene)]bisaniline (bisaniline M).

Further suitable epoxy resins are aliphatic or cycloaliphatic polyepoxides, especially
glycidyl ethers of saturated or unsaturated, branched or unbranched, cyclic or open-chain di-, tri- or tetrafunctional C₂ to C₃₀ alcohols, especially ethylene glycol, propylene glycol, butylene glycol, hexanediol, octanediol, polypropylene glycols, dimethylolcyclohexane, neopentyl glycol, dibromoneopentyl glycol, castor oil, trimethylolpropane, trimethylolethane, pentaerythritol, sorbitol or glycerol, or alkoxylated glycerol or alkoxylated trimethylolpropane;
a hydrogenated bisphenol A, F or NF liquid resin, or the glycidylation products of hydrogenated bisphenol A, F or NF;
an N-glycidyl derivative of amides or heterocyclic nitrogen bases, such as triglycidyl cyanurate or triglycidyl isocyanurate, or reaction products of epichlorohydrin with hydantoin.
epoxy resins from the oxidation of olefins such as, in particular, vinylcyclohexene, dicyclopentadiene, cyclohexadiene, cyclododecadiene, cyclododecatriene, isoprene, 1,5-hexadiene, butadiene, polybutadiene or divinylbenzene.

The epoxy resin is preferably a liquid resin or a mixture containing two or more liquid epoxy resins.

“Liquid epoxy resin” refers to an industrial polyepoxide having a glass transition temperature below 25° C.

The resin component optionally additionally contains proportions of solid epoxy resin.

The epoxy resin is especially a liquid resin based on a bisphenol, in particular a bisphenol A diglycidyl ether and/or bisphenol F diglycidyl ether, as are commercially available, for example, from Olin, Huntsman or Momentive. These liquid resins have a low viscosity for epoxy resins and enable rapid curing and high hardnesses. They may contain proportions of solid bisphenol A resin or novolak glycidyl ethers.

The resin component may contain a reactive diluent.

Preferred reactive diluents are reactive diluents containing epoxy groups, especially butanediol diglycidyl ether, hexanediol diglycidyl ether, trimethylolpropane di- or triglycidyl ether, phenyl glycidyl ether, cresyl glycidyl ether, guaiacol glycidyl ether, 4-methoxyphenyl glycidyl ether, p-n-butylphenyl glycidyl ether, p-tert-butylphenyl glycidyl ether, 4-nonylphenyl glycidyl ether, 4-dodecylphenyl glycidyl ether, cardanol glycidyl ether, benzyl glycidyl ether, allyl glycidyl ether, butyl glycidyl ether, hexyl glycidyl ether, 2-ethylhexyl glycidyl ether, or glycidyl ethers of natural alcohols, such as, in particular, C₈- to C₁₀- or C₁₂- to C₁₄- or C₁₃- to C₁₅-alkyl glycidyl ethers.

The epoxy resin composition preferably contains at least one further constituent selected from the group consisting of thinners, accelerators and fillers.

Suitable accelerators are those already mentioned, especially salicylic acid, calcium nitrate or 2,4,6-tris(dimethylaminomethyl)phenol or a combination thereof.

Suitable thinners are those already mentioned, especially those having a boiling point of more than 200° C.

The thinner is preferably selected from the group consisting of benzyl alcohol, styrenized phenol, ethoxylated phenol, aromatic hydrocarbon resins containing phenol groups, especially the Novares® LS 500, LX 200, LA 300 or LA 700 grades (from Rutgers), diisopropylnaphthalene and cardanol.

The epoxy resin composition preferably contains only a small content of thinners. It preferably contains less than 10% by weight, more preferably less than 5% by weight, especially less than 1% by weight, of thinners. This enables low-emissions or emissions-free epoxy resin products.

Suitable fillers are, in particular, ground or precipitated calcium carbonate, which is optionally coated with fatty acid, in particular stearates, baryte (heavy spar), talc, quartz powder, quartz sand, silicon carbide, iron mica, dolomite, wollastonite, kaolin, mica (potassium aluminum silicate), molecular sieve, aluminum oxide, aluminum hydroxide, magnesium hydroxide, silica, cement, gypsum, fly ash, carbon black, graphite, metal powders such as aluminum, copper, iron, zinc, silver or steel, PVC powder or hollow beads.

Preference is given to calcium carbonate, quartz powder, and quartz sand.

The epoxy resin composition optionally comprises further auxiliaries and additives, in particular the following:
reactive diluents, in particular those already mentioned, or epoxidized soybean oil or linseed oil, compounds containing acetoacetate groups, in particular acetoacetylated polyols, butyrolactone, carbonates, aldehydes, isocyanates or silicones having reactive groups;
solvents;
further amines, especially monoamines such as, in particular, benzylamine or furfurylamine or aromatic polyamines such as, in particular, 4,4′-, 2,4′ and/or 2,2′-diaminodiphenylmethane, 2,4- and/or 2,6-tolylenediamine, 3,5-dimethylthio-2,4-tolylenediamine and/or 3,5-dimethylthio-2,6-tolylenediamine, 3,5-diethyl-2,4-tolylenediamine and/or 3,5-diethyl-2,6-tolylenediamine;
compounds having mercapto groups, in particular liquid mercaptan-terminated polysulfide polymers, mercaptan-terminated polyoxyalkylene ethers, mercaptan-terminated polyoxyalkylene derivatives, polyesters of thiocarboxylic acids, 2,4,6-trimercapto-1,3,5-triazine, triethylene glycol dimercaptan or ethanedithiol;
polymers, in particular polyamides, polysulfides, polyvinyl formal (PVF), polyvinyl butyral (PVB), polyurethanes (PUR), polymers having carboxyl groups, polyamides, butadiene-acrylonitrile copolymers, styrene-acrylonitrile copolymers, butadiene-styrene copolymers, homo- or copolymers of unsaturated monomers, in particular from the group comprising ethylene, propylene, butylene, isobutylene, isoprene, vinyl acetate or alkyl (meth)acrylates, in particular chlorosulfonated polyethylenes or fluorine-containing polymers or sulfonamide-modified melamines;
fibers, in particular glass fibers, carbon fibers, metal fibers, ceramic fibers or polymer fibers such as polyamide fibers or polyethylene fibers;
pigments, in particular titanium dioxide, iron oxides or chromium(III) oxide;
rheology modifiers, in particular thickeners or antisettling agents;
adhesion improvers, in particular organoalkoxysilanes;
flame-retardant substances, in particular the aluminum hydroxide or magnesium hydroxide fillers already mentioned, antimony trioxide, antimony pentoxide, boric acid (B(OH)₃), zinc borate, zinc phosphate, melamine borate, melamine cyanurate, ammonium polyphosphate, melamine phosphate, melamine pyrophosphate, polybrominated diphenyl oxides or diphenyl ethers, phosphates such as, in particular, diphenyl cresyl phosphate, resorcinol bis(diphenylphosphate), resorcinol diphosphate oligomer, tetraphenylresorcinol diphosphite, ethylenediamine diphosphate, bisphenol A bis(diphenylphosphate), tris(chloroethyl) phosphate, tris(chloropropyl) phosphate, tris(dichloroisopropyl) phosphate, tris[3-bromo-2,2-bis(bromomethyl)propyl] phosphate, tetrabromobisphenol A, bis(2,3-dibromopropyl ether) of bisphenol A, brominated epoxy resins, ethylenebis(tetrabromophthalimide), ethylenebis(dibromonorbornanedicarboximide), 1,2-bis(tribromophenoxy)ethane, tris(2,3-dibromopropyl) isocyanurate, tribromophenol, hexabromocyclododecane, bis(hexachlorocyclopentadieno)cyclooctane or chloroparaffins; or
additives, especially dispersed paraffin wax, film-forming auxiliaries, wetting agents, leveling agents, defoamers, deaerators, stabilizers against oxidation, heat, light or UV radiation, or biocides.

In the epoxy resin composition, the ratio of the number of groups reactive toward epoxy groups relative to the number of epoxy groups is preferably in the range from 0.5 to 1.5, in particular 0.7 to 1.2.

The primary and secondary amino groups present in the epoxy resin composition, and any other groups present that are reactive toward epoxy groups, react with the epoxy groups, resulting in ring opening (addition reaction) thereof. As a result primarily of this reaction, the composition polymerizes and thereby cures.

The resin component and the curing agent component of the epoxy resin composition are stored in separate containers. Further constituents of the epoxy resin composition may be present as a constituent of the resin component or of the curing agent component; further constituents reactive toward epoxy groups are preferably a constituent of the curing agent component. It is likewise possible for further constituents to be present as a dedicated, separate component.

A suitable container for storage of the resin component or the curing agent component is especially a vat, a hobbock, a bag, a bucket, a can, a cartridge or a tube. The components are storable, meaning that they can be stored prior to use for several months up to one year or longer without any change in their respective properties to a degree relevant to their use. For the use of the epoxy resin composition, the components are mixed with one another shortly before or during application. The mixing ratio between the resin component and the curing agent component is preferably chosen such that the groups of the curing agent component that are reactive toward epoxy groups are in a suitable ratio to the epoxy groups of the resin component, as described above. In parts by weight, the mixing ratio between the resin component and the curing agent component is typically in the range from 1:10 to 10:1.

The components are mixed by means of a suitable method; this mixing may be done continuously or batchwise. If the mixing does not immediately precede the application, it has to be ensured that not too much time passes between the mixing of the components and the application and that the application is effected within the pot life. The mixing is especially effected at ambient temperature, which is typically within the range from about 5 to 40° C., preferably about 10 to 35° C. Curing by chemical reaction begins with the mixing of the two components, as described above. The curing typically proceeds at a temperature in the range from 0 to 150° C. It preferably proceeds at ambient temperature and typically extends over a few days to weeks. The duration depends upon factors including the temperature, the reactivity of the constituents, and the stoichiometry thereof, and on the presence of accelerators.

The epoxy resin composition is applied to at least one substrate, the following substrates being particularly suitable:
glass, glass ceramic, concrete, mortar, cement screed, fiber cement, brick, tile, gypsum and natural rocks such as granite or marble;
repair or leveling compounds based on PCC (polymer-modified cement mortar) or ECC (epoxy resin-modified cement mortar);
metals or alloys such as aluminum, iron, steel, copper, other nonferrous metals, including surface-upgraded metals or alloys such as galvanized or chrome-plated metals;
asphalt or bitumen;
leather, textiles, paper, wood, wood-based materials bonded with resins, e.g. phenolic, melamine or epoxy resins, resin-textile composites or further so-called polymer composites;
plastics, such as rigid and flexible PVC, polycarbonate, polystyrene, polyester, polyamide, PMMA, ABS, SAN, epoxy resins, phenolic resins, PUR, POM, TPO, PE, PP, EPM or EPDM, in each case untreated or surface-treated, for example by means of plasma, corona or flames;
fiber-reinforced plastics, such as carbon fiber-reinforced plastics (CFP), glass fiber-reinforced plastics (GFP) and sheet molding compounds (SMC);
insulation foams, especially made of EPS, XPS, PUR, PIR, rock wool, glass wool or foamed glass;
coated or painted substrates, especially painted tiles, coated concrete, powder-coated metals or alloys or painted metal sheets;
coatings, paints or varnishes, especially coated floors that have been overcoated with a further floor covering layer.

If required, the substrates can be pretreated prior to application, especially by physical and/or chemical cleaning methods or the application of an activator or a primer.

The curing of the epoxy resin composition described affords a cured composition.

The epoxy resin composition described is preferably used as adhesive, sealant, encapsulating compound, casting resin, coating, primer or as matrix for fiber composites such as, in particular, CFRP or GFRP. The term “coating” also covers primers, paints, varnishes and sealants.

Particular preference is given to using the epoxy resin composition described as adhesive. In this case, after the components have been mixed, it typically has a pasty consistency with structurally viscous properties. On application, the mixed adhesive is applied within the pot life to at least one of the substrates to be bonded and the substrates are joined to form an adhesive bond within the open time of the adhesive.

The mixed adhesive is applied especially by means of a brush, roll, spatula, doctor blade or trowel, or from a tube, cartridge or metering device.

The adhesive is particularly suitable for uses in the construction industry, especially for the reinforcement of built structures by means of steel elements or elements made of carbon fiber-reinforced composite plastics (CFRP), for constructions containing bonded precast concrete components, especially bridges or concrete towers, for example for wind turbines, shafts, pipelines or tunnels, or for constructions containing bonded natural rocks, ceramic elements or parts made of fiber cement, steel, cast iron, aluminum, wood or polyester, for the anchoring of anchors or steel bars in boreholes, the fixing of, for example, banisters, railings or doorframes, for repairs such as, in particular, the filling of edges, holes or joins in concrete maintenance, or for the bonding of films of polyvinylchloride (PVC), flexibilized polyolefin (Combiflex®) or adhesion-modified chlorosulfonated polyethylene (Hypalon®) to concrete or steel.

Further fields of use relate to structural bonding in the construction or manufacturing industry, especially as adhesive mortar, assembly adhesive, reinforcement adhesive such as, in particular, for the bonding of lamellas of CFRP or steel to concrete, brickwork or wood, as element adhesive, for example for bridge elements, sandwich element adhesive, façade element adhesive, reinforcing adhesive, bodywork adhesive or half-shell adhesive for rotor blades of wind turbines.

Such an epoxy resin adhesive is likewise suitable for the filling of cavities such as fissures, cracks or boreholes, wherein the adhesive is filled or injected into the cavity and fills it after curing, and bonds or sticks the flanks of the cavity to one another in a force-fitting manner.

The invention further provides a method of bonding, comprising the steps of

(i) mixing the components of the epoxy resin composition described,
(ii) applying the mixed composition within the pot life,
either to at least one of the substrates to be bonded and joining the substrates to form a bond within the open time,
or into a cavity or gap between two or more substrates and optionally inserting an anchor into the cavity or gap within the open time,
   followed by the curing of the mixed composition.

An “anchor” refers here more particularly to a rebar, a threaded rod or a bolt. An anchor is especially adhesively bonded or anchored in a wall, ceiling or foundation in such a way that a portion thereof is bonded in a force-fitting manner and a portion thereof protrudes and can be subjected to a construction load. Identical or different substrates may be bonded.

The application and curing of the epoxy resin composition described, or the method of bonding, results in an article. This article may be a built structure or a part thereof, especially a built structure above or below ground, a bridge, a roof, a staircase, a balcony, or it may be an industrial good or a consumer good, especially a pier, an offshore platform, a rotor blade of a wind turbine, or a mode of transport, such as especially an automobile, a truck, a rail vehicle, a ship, an aircraft or a helicopter, or an installable component thereof.

The invention thus further provides an article obtained from the described use or the described method of bonding.

The epoxy resin composition described features advantageous properties. It also has good processibility even without thinner, has a long pot life and open time coupled with rapid curing, and cures to give material of high strength, low brittleness, high bond strengths and sufficiently high glass transition temperature.

Articles bonded therewith also withstand severe mechanical and weathering-related stresses.

### EXAMPLES

Working examples are adduced hereinafter, which are intended to elucidate the invention described. The invention is of course not limited to these described working examples.

“ANEW” stands for amine hydrogen equivalent weight.
“EEW” stands for epoxy equivalent weight.
“Standard climatic conditions” (“SCC”) refer to a temperature of 23±1° C. and a relative air humidity of 50±5%.

### Description of the Measurement Methods:

Viscosity was measured on a thermostated Rheotec RC30 cone-plate viscometer (cone diameter 50 mm, cone angle 1°, cone tip-plate distance 0.05 mm, shear rate 10 s⁻¹).

Amine value was determined by means of titration (with 0.1N HClO₄ in acetic acid versus crystal violet).

### Substances and Abbreviations Used:

Sikadur®-30 (A) Sikadur®-30 component A, quartz-filled resin component of a structural epoxy resin adhesive, containing bisphenol A diglycidyl ether and butane-1,4-diol diglycidyl ether, EEW about 700 g/eq (from Sika)
B-EDA N-benzylethane-1,2-diamine, prepared as described below, AHEW 50 g/eq
DMAPAPA 3-(3-(dimethylamino)propylamino)propylamine, AHEW 53 g/eq (DMAPAPA, from Arkema).
TEPA tetraethylenepentamine, AHEW about 30 g/eq (technical grade, from Huntsman)
BHMT technical grade quality of bis(6-aminohexyl)amine with a purity in the range from 50% to 78% by weight, AHEW about 48 g/eq (Dytek® BHMT Amine (50-78%), from Invista)
Quartz flour grain size 0 to 75 μm
Quartz sand grain size 0.1 to 0.3 mm
Precipitated chalk stearate-coated precipitated chalk (Socal® U1S2, from Solvay)

B-EDA is an amine A1 of the formula (I). DMAPAPA is an amine A2 of the formula (II).

### N-Benzylethane-1,2-diamine (B-EDA)

A round-bottom flask was initially charged with 180.3 g (3 mol) of ethylene-1,2-diamine under a nitrogen atmosphere at room temperature. With good stirring, a solution of 106.0 g (1 mol) of benzaldehyde in 1200 ml of isopropanol was slowly added dropwise, and the mixture was stirred for 2 hours. The reaction mixture was then hydrogenated in a continuous hydrogenation apparatus with a Pd/C fixed bed catalyst at a hydrogen pressure of 80 bar, a temperature of 80° C. and a flow rate of 5 ml/min. To monitor the reaction, IR spectroscopy was used to check whether the imine band at about 1665 cm⁻¹ had disappeared. Thereafter, the hydrogenated solution was concentrated on a rotary evaporator at 65° C., removing unreacted ethylene-1,2-diamine, water and isopropanol. The reaction mixture thus obtained was a clear, pale yellowish liquid having an amine value of 678 mg KOH/g. 50 g of this were distilled at 80° C. under reduced pressure, with collection of 31.3 g of distillate at a vapor temperature of 60 to 65° C. and 0.06 mbar. What was obtained was a colorless liquid having a viscosity of 8.3 mPa·s at 20° C., an amine value of 750 mg KOH/g and a purity, determined by GC, of >97%.

### Production of Epoxy Resin Adhesives:

### Examples 1 to 11

For each example, the ingredients of the curing agent component indicated in tables 1 to 2 were mixed in the indicated amounts (in parts by weight) by means of a centrifugal mixer (SpeedMixer™ DAC 150, FlackTek Inc.) and stored with the exclusion of moisture.

The resin component used was Sikadur®-30 component A (from Sika) in the amount specified in tables 1 and 2 (in parts by weight).

For each example, the resin and the curing agent component were then processed by means of the centrifugal mixer to give a homogeneous paste and this was immediately tested as follows:

Pot life was determined under standard climatic conditions by moving the mixed adhesive by means of a spatula every 5 min until the adhesive had thickened to such an extent that it was no longer processible.

Mechanical properties were tested by applying and curing the mixed adhesive under standard climatic conditions to a silicone mold to give dumbbell-shaped specimens having a thickness of 10 mm and a length of 150 mm with a gage length of 80 mm and a gage width of 10 mm. The tensile specimens were removed from the mold after a curing time of 7 days, and these were used to determine tensile strength and elongation at break to EN ISO 527 at a strain rate of 1 mm/min.

The characteristics of the surface were assessed on the dumbbell-shaped specimens to determine the mechanical properties on the side exposed to the air in the course of curing. A non-tacky surface was referred to as “smooth”, and a tacky surface as “sticky”. A tacky surface is a sign of blushing.

Lap shear strength on steel (LSS steel) was measured by producing multiple adhesive bonds, wherein the mixed adhesive was applied between two heptane-degreased steel sheets in a layer thickness of 0.5 mm with an overlapping bonding area of 10×25 mm. After a storage time of 7 days under standard climatic conditions, lap shear strength was determined to DIN EN 1465 at a strain rate of 10 mm/min.

Lap shear strength on carbon fiber composite (CFRP) (LSS CFRP) was measured by producing multiple adhesive bonds, wherein the mixed adhesive was applied between two heptane-degreased Sika® CarboDur® S512 lamellas in a layer thickness of 0.5 mm with an overlapping bonding area of 10×50 mm. After a storage time of 7 days under standard climatic conditions, lap shear strength was determined as described.

Compressive strength was determined by applying the mixed adhesive under standard climatic conditions in a silicone mold to give cuboids of dimensions 12.7×12.7×25.4 mm and curing them under standard climatic conditions. After 7 days, several such cuboids were removed from the mold and compressed to destruction as per ASTM D695 at a testing speed of 1.3 mm/min, reading off the compressive strength value at the maximum force in each case.

Tg (glass transition temperature) was determined by means of DSC on cured adhesive samples that had been stored under standard climatic conditions for 14 days with a Mettler Toledo DSC 3+700 instrument and the following measurement program: (1) −10° C. for 2 min, (2) −10 to 200° C. at a heating rate of 10 K/min (=1st run), (3) 200 to −10° C. at a cooling rate of −50 K/m in, (4) −10° C. for 2 min, (5) −10 to 180° C. at a heating rate of 10 K/min (=2nd run).

The results are reported in tables 1 to 2.

The examples labeled “(Ref.)” are comparative examples.

TABLE 1
Composition and properties of examples 1 to 6.

| | 1 | | | | 5 | 6 |
|---|---|---|---|---|---|---|
| Example | (Ref.) | 2 | 3 | 4 | (Ref.) | (Ref.) |
| Resin comp.: | 300.0 | 300.0 | 300.0 | 300.0 | 300.0 | 300.0 |
| Sikadur ®-30 (A) | | | | | | |
| Curing agent comp.: | 21.5 | 18.7 | 15.8 | 11.1 | 6.4 | — |
| B-EDA | | | | | | |
| DMAPAPA | — | 3.0 | 6.0 | 11.0 | 16.0 | 22.7 |
| Quartz flour | 35.3 | 35.3 | 35.2 | 34.9 | 34.8 | 34.5 |
| Quartz sand | 28.2 | 28.0 | 28.0 | 28.0 | 27.8 | 27.8 |
| Precipitated chalk | 15.0 | 15.0 | 15.0 | 15.0 | 15.0 | 15.0 |
| A1/A2 ratio¹ | — | 6.2/1 | 2.6/1 | 1/1 | 1/2.5 | — |
| Pot life [h:min] | 2:00 | 1:45 | 1:30 | 1:15 | 1:05 | 0:45 |
| Tensile strength: | 34 | 37 | 35 | 33 | 32 | 31 |
| [MPa] | | | | | | |
| Elongation at break: | 0.3 | 0.3 | 0.3 | 0.2 | 0.2 | 0.2 |
| [%] | | | | | | |
| Surface | smooth | smooth | smooth | smooth | sticky | sticky |
| LSS steel [MPa] | 6.2 | 9.1 | 11.2 | 13.7 | 14.9 | 16.6 |
| LSS CFRP [MPa] | 8.3 | 8.4 | 8.5 | 8.2 | 8.1 | 9.5 |
| Compressive | 90 | 96 | 109 | 110 | 115 | 115 |
| strength: [MPa] | | | | | | |
| Tg 1st/2nd run [° C.] | 48/57 | 52/58 | 58/60 | 60/59 | 55/38 | 45/32 |

¹Weight ratio between amine A1 and amine A2

TABLE 2
Composition and properties of examples 7 to 11.

| Example | 7 | 8 | 9 | 10 | 11 |
|---|---|---|---|---|---|
| Resin comp.: | 300.0 | 300.0 | 300.0 | 300.0 | 300.0 |
| Sikadur ®-30 (A) | | | | | |
| Curing agent comp.: | 13.6 | 10.8 | 10.8 | 7.1 | 5.6 |
| B-EDA | | | | | |
| DMAPAPA | 6.0 | 6.0 | 6.0 | 6.0 | 6.0 |
| TEPA | 1.5 | 3.0 | — | 3.0 | 3.0 |
| BHMT | — | — | 4.8 | 3.5 | 5.0 |
| Quartz flour | 35.2 | 36.5 | 34.7 | 36.6 | 36.6 |
| Quartz sand | 28.7 | 28.7 | 28.7 | 28.8 | 28.8 |
| Precipitated chalk | 15.0 | 15.0 | 15.0 | 15.0 | 15.0 |
| A1/A2 ratio¹ | 2.3/1 | 1.8/1 | 1.8/1 | 1.2/1 | 1/1.1 |
| Pot life [h:min] | 1:20 | 1:15 | 1:30 | 1:30 | 1:30 |
| Tensile strength: [MPa] | 36 | 33 | 40 | 37 | 35 |
| Elongation at break: [%] | 0.3 | 0.2 | 0.3 | 0.3 | 0.3 |
| Surface | smooth | smooth | smooth | smooth | smooth |
| LSS steel [MPa] | 10.6 | 9.9 | 12.5 | 13.7 | 15.2 |
| LSS CFRP [MPa] | 9.0 | 10.0 | 12.1 | 10.2 | 10.0 |
| Compressive | 111 | 107 | 111 | 109 | 110 |
| strength: [MPa] | | | | | |
| Tg 1st/2nd run [° C.] | 58/68 | 59/68 | 57/63 | 61/64 | 61/69 |

¹Weight ratio between amine A1 and amine A2

1. A curing agent for epoxy resins, comprising at least one amine A1 of the formula (I) and at least one amine A2 of the formula (II) 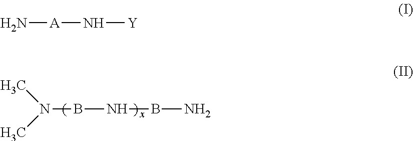
where
A is an alkylene radical that optionally contains nitrogen atoms or cyclic or aromatic components and has 2 to 10 carbon atoms,
Y is an alkyl, cycloalkyl or aralkyl radical having 1 to 20 carbon atoms,
x is 1 or 2, and
B represents identical or different alkylene radicals selected from 1,2-ethylene, 1,2-propylene and 1,3-propylene,
where the weight ratio between amine A1 and amine A2 is in the range from 20/1 to 1/2.

2. The curing agent as claimed in claim 1, wherein A is a divalent radical selected from the group consisting of 1,2-ethylene, 1,2-propylene, 1,3-propylene, 1,4-butylene, 1,3-butylene, 2-methyl-1,2-propylene, 1,3-pentylene, 1,5-pentylene, 2,2-dimethyl-1,3-propylene, 1,6-hexylene, 2-methyl-1,5-pentylene, 1,7-heptylene, 1,8-octylene, 2,5-dimethyl-1,6-hexylene, 1,9-nonylene, 2,2(4),4-trimethyl-1,6-hexylene, 1,10-decylene, 1,11-undecylene, 2-butyl-2-ethyl-1,5-pentylene, 1,12-dodecylene, 1,2-cyclohexylene, 1,3-cyclohexylene, 1,4-cyclohexylene, (1,5,5-trimethylcyclohexan-1-yl)methane-1,3,4(2)-methyl-1,3-cyclohexylene, 1,3-cyclohexylenebis(methylene), 1,4-cyclohexylenebis(methylene), 1,3-phenylenebis(methylene), 1,4-phenylenebis(methylene), 3-aza-1,5-pentylene, 3,6-diaza-1,8-octylene, 3,6,9-triaza-1,11-undecylene, 3-aza-1,6-hexylene and 3,7-diaza-1,9-nonylene.

3. The curing agent as claimed in claim 1, wherein A is 1,2-ethylene or 1,2-propylene.

4. The curing agent as claimed in claim 1, wherein Y is a radical selected from 2-ethylhexyl, 2-phenylethyl, benzyl, 1-naphthylmethyl and cyclohexylmethyl.

5. The curing agent as claimed in claim 1, wherein the amine A1 of the formula (I) is N-benzylethane-1,2-diamine.

6. The curing agent as claimed in claim 1, wherein the amine A2 of the formula (II) is 3-(3-(dimethylamino)propylamino)propylamine.

7. The curing agent as claimed in claim 1, wherein it comprises at least one further amine.

8. The curing agent as claimed in claim 7, wherein the further amine is an amine A3 of the formula (III).
Y—NH-A-NH—Y (III)

9. The curing agent as claimed in claim 7, wherein the further amine is an amine A4 which is an aliphatic polyamine having at least two primary amino groups.

10. The curing agent as claimed in claim 9, wherein the amine A4 is a polyalkyleneamine.

11. An epoxy resin composition comprising
a resin component comprising at least one epoxy resin and
a curing agent component comprising the curing agent as claimed in claim 1.

12. The epoxy resin composition as claimed in claim 11, wherein it comprises at least one further constituent selected from the group consisting of thinners, accelerators and fillers.

13. A method comprising using the epoxy resin composition as claimed in claim 11 as adhesive, sealant, encapsulating compound, casting resin, coating, primer or as matrix for fiber composite materials.

14. A method of bonding, comprising the steps of
(i) mixing the components of the epoxy resin composition as claimed in claim 11,
(ii) applying the mixed composition within the pot life,
either to at least one of the substrates to be bonded and joining the substrates to form a bond within the open time,
or into a cavity or gap between two or more substrates and optionally inserting an anchor into the cavity or gap within the open time,
followed by the curing of the mixed composition.

15. An article obtained from the method as claimed in claim 14.
